(19) United States
(12) Patent Application Publication
(10) Pub. No.: US 2016/0067675 A1
(43) Pub. Date: Mar. 10, 2016

(54) Magnetic Absorbent Material and Methods of Using the Same

(71) Applicant: Mark Schneider, Crystal Lake, IL (US)

(72) Inventor: Mark Schneider, Crystal Lake, IL (US)

(21) Appl. No.: 14/846,325

(22) Filed: Sep. 4, 2015

Related U.S. Application Data
(60) Provisional application No. 62/045,857, filed on Sep. 4, 2014.

(51) Int. Cl. B01J 20/28; A63B 53/04; F21V 21/096; F21V 23/04; F26B 5/16; F21L 4/08

(52) U.S. Cl. CPC B01J 20/28009; F26B 5/16; F21L 4/08; F21V 21/0965; F21V 23/0464; A63B 53/0466

(57) ABSTRACT

The present invention relates to a magnetic absorbent material. Specifically, the present invention relates to an absorbent material with at least one magnetic location therein. The present invention may further have reflective material, a power source, and/or at least one light source.

The present invention claims priority to U.S. Prov. Pat. App. No. 62/045,857, titled “Magnetic Absorbent Material and Methods of Using the Same,” filed Sep. 4, 2014, which is incorporate herein by reference in its entirety.

### TECHNICAL FIELD

The present invention relates to a magnetic absorbent material. Specifically, the present invention relates to an absorbent material with at least one magnetic location therein. The present invention may further have reflective material, a power source, and/or at least one light source.

### BACKGROUND

It is, of course, generally known that absorbent material is used to soak up water, fluids, debris, and/or other substances. Often, it is necessary to absorb liquids that may spill from a container or the like. Absorbent materials may act against such spills if available and accessible.

Accessibility of absorbent materials is a common problem. Absorbent materials are often bulky in order to be able to absorb a maximum amount of fluid. Therefore, absorbent materials are often stored away in shelves, cabinets, drawers, bags, pockets, trunks, or other alternate storage area. In order to clean up a spill, one must leave the spill area, open the storage area designated to store the absorbent material, grab an amount of material needed to contain or clean up the spill, return to the spill, and repeat as necessary if the amount of material grabbed is insufficient.

One solution to the accessibility problem is to provide racks to hang absorbent materials in locations where spills occur with high frequency or where there is a high probability of spilling. However, these racks are not always around when necessary, especially when a user is outside or on the go.

Absorbent materials are also useful for outdoor activities, such as sports, in order to absorb sweat, to cool a person with an absorbent material that has absorbed cold water, to relax muscles of a person with an absorbent material that has absorbed hot water, to clean sports gear, to absorb spills on the go, or to wipe off cold beverages. A need exists for an absorbent material that is easily accessible where racks are incapable of being provided or are just not provided. Specifically, a need exists for an absorbent material that is attachable to sports equipment for easy access.

Sometimes it is difficult to locate absorbent materials either because they have been misplaced, discarded, or cannot be located due to a lack of light. Often, absorbent material is not biodegradable. Negligent misplacement and/or discarding said material can be dangerous to the environment, animal life, or human life. A need exists for an absorbent material that is easily identifiable and locatable for reuse and/or proper disposal thereof.

### SUMMARY OF THE INVENTION

The present invention relates to a magnetic absorbent material. Specifically, the present invention relates to an absorbent material with at least one magnetic location therein. The present invention may further have reflective material, a power source, and/or at least one light source

To this end, in an embodiment of the present invention, an apparatus is provided. The apparatus comprises an absorbent material, wherein at least one portion of the absorbent material is magnetized.

In an alternate embodiment of the present invention, an apparatus is provided. The apparatus comprises an absorbent material, wherein at least one portion of the absorbent material is magnetized, and further wherein at least one portion of the absorbent material is reflective.

In an alternate embodiment of the present invention, an apparatus is provided. The apparatus comprises an absorbent material, wherein at least one portion of the absorbent material is magnetized; and a solar cell, a battery, and a plurality of lights electrically connected together and disposed on a portion of the absorbent material, wherein light entering the solar cell charges the battery and provides power to illuminate the plurality of lights.

In an alternate embodiment of the present invention a method is provided. The method comprises the steps of providing an apparatus comprising an absorbent material, wherein at least one portion of the absorbent material is magnetized, and allowing the absorbent material to be attached to an object magnetically.

It is, therefore, an advantage and objective of the present invention to provide an absorbent material that is easily accessible where racks are incapable of being provided or are just not provided

It is an advantage and objective of the present invention to provide an absorbent material that is attachable to sports equipment for easy access.

It is an advantage and objective of the present invention to provide an absorbent material that is easily identifiable and locatable for reuse and/or proper disposal thereof.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a magnetic absorbent apparatus in an embodiment of the present invention.

FIG. 2 illustrates a perspective view of a magnetic absorbent apparatus attached to itself in an embodiment of the present invention.

FIG. 3 illustrates a perspective view of the magnetic absorbent apparatus being picked up by a piece of sports equipment in an embodiment of the present invention.

FIG. 4 illustrates a perspective view of a magnetic absorbent apparatus with a reflective portion in an embodiment of the present invention.

FIG. 5 illustrates a perspective view of a magnetic absorbent apparatus with a plurality of lights in an embodiment of the present invention.

### DETAILED DESCRIPTION OF THE PRESENTLY PREFERRED EMBODIMENTS

The present invention relates to a magnetic absorbent material. Specifically, the present invention relates to an absorbent material with at least one magnetic location therein. The present invention may further have reflective material, a power source, and/or at least one light source.

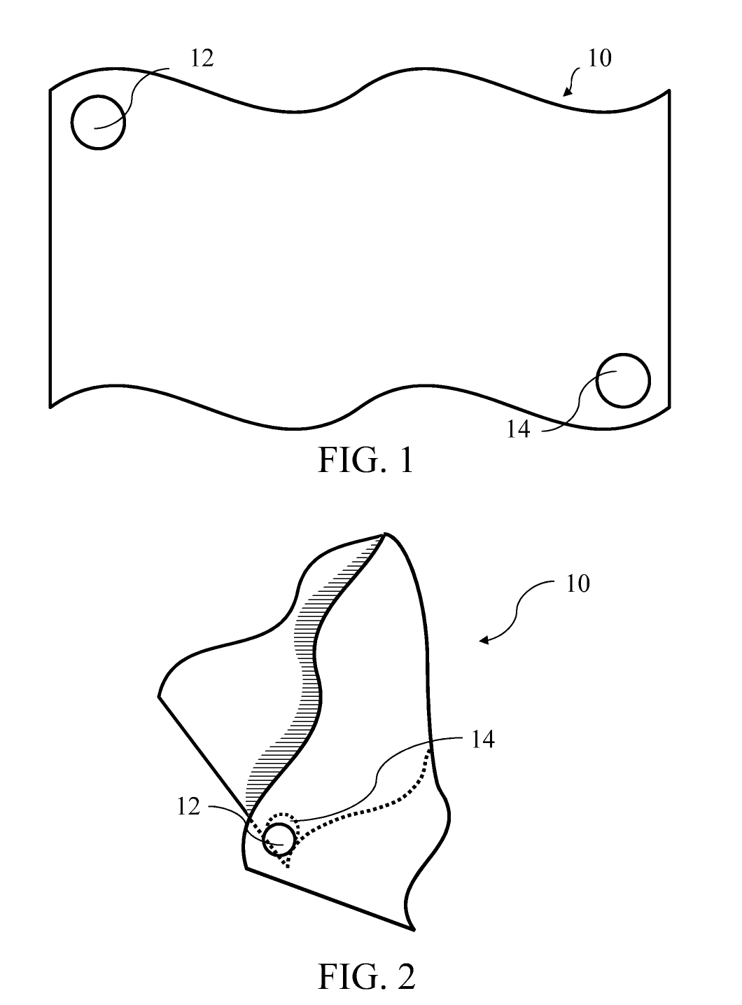

Now referring to the figures, wherein like numerals refer to like parts, FIG. 1 illustrates, an absorbent apparatus 10. The absorbent apparatus 10 may be made from an absorbent material, such as a towel, chamois leather, synthetic microfiber, or other porous and/or absorbent material known to one skilled in the art. The absorbent apparatus 10 may have a magnetic portion 12 disposed within the absorbent apparatus 10. The magnetic portion 12 may merely be a permanent magnet sewn within the absorbent material, but may also be a ferromagnetic material capable of being magnetized, an electromagnet created by a coil of wire wrapped around a metal, any combination thereof, or other magnetic material known to one skilled in the art. Alternatively, the absorbent apparatus 10 may contain a plurality of small magnets disposed throughout the absorbent material, such as magnets sizing around one millimeter, which may allow the entire absorbent material to be magnetized while remaining flexible and absorptive.

The magnetic portion 12 may be any shape and may be attached directly to the absorbent apparatus 10 instead of being sewn therein. In one embodiment, the magnetic portion 12 may be within the hem of the absorbent apparatus. In an alternate embodiment, the magnetic portion may be attached to the absorbent apparatus 10 with a rope, chain, string, or other attaching device. The magnetic portion 12 may allow the absorbent apparatus 10 to be placed, hung, or otherwise attached to any magnetic or ferromagnetic material. For example, the absorbent apparatus 10 may be hung from appliances in a kitchen, taps or other equipment in bars and restaurants, around the house, outside on fences, benches, automobiles, sports equipment, or on other magnetizable materials, etc. The magnetic portion 12 may thus provide a plurality of additional locations to place, hang, or otherwise attach absorbent materials thereto.

As noted, the magnetic portion 12 may be made from permanent magnets and/or induced magnets, and may take any shape or form. For example, permanent magnets may include disc-shaped magnets, spherical magnets, bars, U-shaped magnets and the like. In a preferred embodiment, the permanent magnets may be spherical or flat with rounded edges to prevent pinching or otherwise allow the magnets to easily be separate by grasping and pulling apart from another magnet or a metal surface to which the magnets are attracted.

The absorbent apparatus 10 may further have a linking portion 14, which may be disposed at an opposite end of the absorbent apparatus 10 away from the magnetic portion 12. As shown in FIG. 1, the magnetic portion 12 may be in a top left corner of the absorbent apparatus 10 and the linking portion 14 may be in a bottom right corner of the absorbent apparatus 10. Of course, the magnetic portion 12 and linking portion 14 may be placed anywhere in or on the absorbent apparatus 10. The linking portion 14 may also be a permanent magnet, a ferromagnetic material capable of being magnetized, an electromagnet, any combination thereof, or other magnetic material known to one skilled in the art. However the poles of the magnetic field created by the linking portion 14 may be opposite of the poles of the magnetic field created by the magnetic portion 14 such that the linking portion 14 may be attracted to the magnetic portion 14.

In one embodiment, the linking portion 14 may merely be a ferromagnetic material, such as iron, nickel, cobalt, or other like magnetizable material. When the magnetic portion 12 is brought in close proximity to the linking portion 14, the magnetic field of the magnetic portion 12 may create a reverse magnetic field in the linking portion 14 such that the linking portion 14 is attracted to the magnetic portion 12. The linking portion 14 and the magnetic portion 12 may then be magnetically connected even though the linking portion 14 may not be a permanent magnet.

As shown in FIG. 2, when the linking portion 14 is magnetically connected to the magnetic portion 12, the absorbent apparatus 10 may form a loop, or opening, between a middle of the absorbent apparatus 10 and the magnetically connected magnetic portion 12 and linking portion 14. Therefore, the absorbent apparatus 10 may be looped, wrapped, hooked, or slung around any object and may be secured from falling from the object when the magnetic portion 12 connects to the linking portion 14. In this embodiment, the absorbent apparatus 10 may be secured around any object, and not just magnetizable materials.

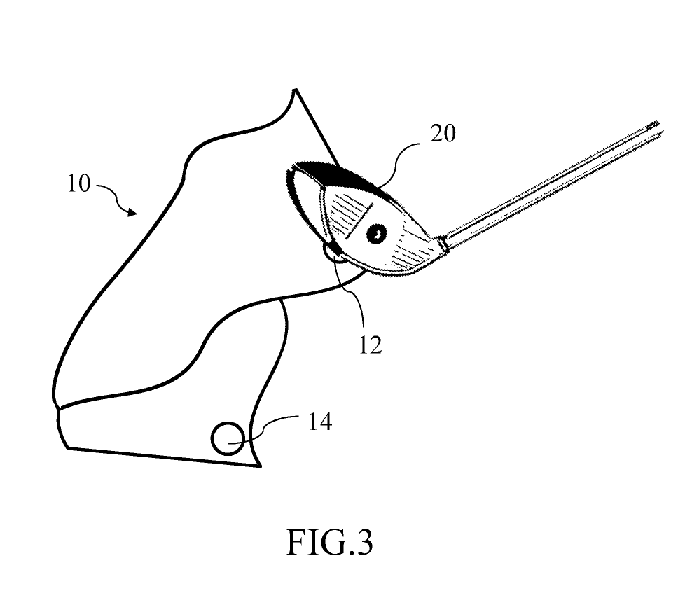

In an alternate embodiment of the present invention, a practical application of the present invention is shown in FIG. 3. The absorbent apparatus 10 may be picked up utilizing sports equipment, such as a golf club 20. The absorbent apparatus 10 may be magnetically connected to sports equipment not just for easy access but also for easy return. For example, a person may loop, wrap, hook or sling the absorbent apparatus 10 around a handle of a golf bag. Alternatively, the person may magnetically connect the absorbent apparatus 10 to an unused golf club. When the person begins to sweat, needs to wipe off a cold beverage, needs to clean a golf ball, or the like, the absorbent apparatus 10 may be pulled from the golf bag or club and used. The person may discard the absorbent apparatus 10, perhaps to tee off, and may pick up the absorbent apparatus 10 thereafter without having to bend over to pick it up. The person may utilize the golf club, or other sports equipment in alternate scenarios, to magnetically connect the absorbent apparatus 10 thereto and return both the absorbent apparatus 10 and the golf club 20 to the golf bag.

Of course, this method may be used in multiple scenarios, and the present example is used for illustrational purposes only and is not meant to be limiting. For example, the absorbent apparatus 10 of the present invention may be utilized in other applications, such as in kitchens, bars, restaurants, or other like facilities, where the absorbent apparatus may be stored on a metallic article or surface, such as on a refrigerator, on a stove, oven, grill, by a sink for drying dishes, or in other like locations, and the present invention should not be limited as described herein.

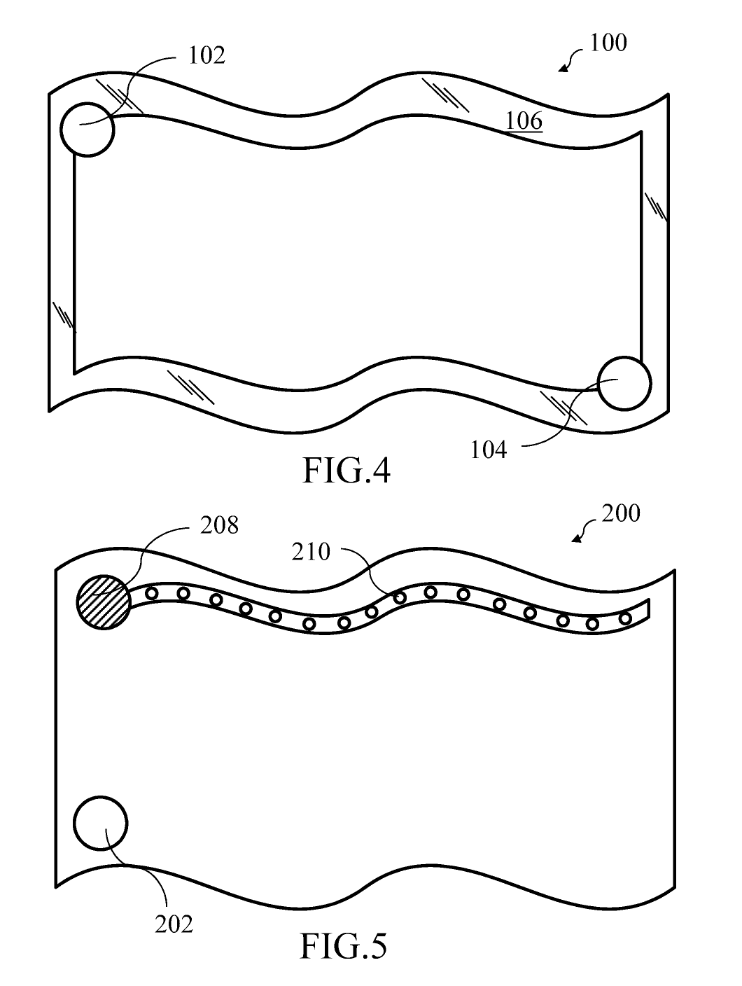

An alternate embodiment of the present invention is shown in FIG. 4. Specifically, an absorbent apparatus 100 may comprise a reflective portion 106. The reflective portion 106 may overlay, or alternatively underlay, a magnetic portion 102 and a linking portion 104. The reflective portion 106 may border the absorbent apparatus 100, or alternatively may be on only one side or a plurality of sides. In another alternate embodiment, the entire absorbent apparatus 100 may be reflective. The reflective portion 106 may be able to reflect light toward a person when light is shined thereon. Specifically, the reflective portion 106 may be a bright color, such a yellow, such that the reflected light is bright and noticeable. The reflective portion 106 may attract the attention of a person such that the absorbent apparatus 100 may be found if misplaced, improperly discarded, or otherwise lost.

Another alternate embodiment is shown in FIG. 5. An absorbent apparatus 200 may comprise a solar cell 208, a battery, and a plurality of light emitting diodes 210. The solar cell 208 may be disposed within one corner of the absorbent apparatus 200 and may be electrically connected to the battery. As light enters the solar cell 208, the solar cell 208 may convert the captured light into electricity, which may be used to charge the battery. The battery may be electrically connected to the plurality of light emitting diodes 210 for illumination thereof. Of course, other light sources known to one skilled in the art may be used instead of light emitting diodes. A magnetic portion 202 may be disposed a length away from the solar cell 208, battery, and plurality of light emitting diodes 210 so that the magnetic field created by the magnetic portion 202 does not interfere with the solar cell 208, battery, and/or plurality of light emitting diodes 210.

The absorbent apparatus 200 may further have a sensor or a timer that may determine when the sun sets or when there is an absence of light. This sensor or timer may trigger when no light is present and may connect the battery to the plurality of light emitting diodes 210. This may allow the absorbent apparatus 200 to illuminate only when necessary, in order for a person to locate a misplaced, improperly discarded, or otherwise lost absorbent apparatus 200.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1. An apparatus comprising:
an absorbent material, wherein at least one portion of the absorbent material is magnetized.

2. The apparatus of claim 1, wherein at least one portion of the absorbent material is reflective.

3. The apparatus of claim 1 further comprising:
a solar cell, a battery, and at least one light disposed on a portion of the absorbent material, wherein light entering the solar cell charges the battery and provides power to illuminate the plurality of lights.

4. (canceled)

5. The apparatus of claim 1 wherein the absorbent material is a towel.

6. The apparatus of claim 1 further comprising:
a pocket in the absorbent material; and
a magnet disposed within the pocket, causing the at least one portion of the absorbent to be magnetized.

7. The apparatus of claim 1 further comprising:
a plurality of pockets in the absorbent material; and
a magnet disposed in each of the plurality of pockets.

8. The apparatus of claim 7 wherein the absorbent material comprises a first surface, wherein the plurality of pockets is disposed over an entirety of the first surface.

9. The apparatus of claim 7 wherein the absorbent material comprises a perimeter, and further wherein the plurality of pockets is disposed at the perimeter of the absorbent material.

10. The apparatus of claim 9 wherein the plurality of pockets is disposed around the entirety of the perimeter of the absorbent material.

11. The apparatus of claim 1 comprising:
at least one magnet adhered to the absorbent material causing the at least one portion of the absorbent material to be magnetized.

12. The apparatus of claim 3 further comprising:
a light detector configured to switch the at least one light on in the absence of light.

13. The apparatus of claim 3 comprising:
a plurality of lights disposed on the absorbent material electrically connected together and to the battery.

14. A method of using a magnetic absorbent material, comprising the steps of:
providing an apparatus comprising an absorbent material, wherein at least a portion of the absorbent material is magnetized; and
magnetically attaching the absorbent material to an object.

15. The method of claim 14 wherein the object is made of metal.

16. The method of claim 14 wherein the object comprises a magnet, and the absorbent material is magnetically attached to the magnet of the object.

17. The method of claim 14 wherein the object is a golf club, and further comprising the step of:
aligning the head of the golf club with the absorbent material; and
magnetically attaching the absorbent material to the head of the golf club.

18. The method of claim 17 further comprising the step of:
raising the absorbent material with the golf club.

19. The method of claim 14 wherein at least one portion of the absorbent material is reflective.

20. The method of claim 14 wherein the absorbent material further comprises a solar cell, a battery, at least one light, wherein light entering the solar cell charges the battery and provides power to illuminate the plurality of lights.

21. The method of claim 20 wherein the absorbent material comprises a plurality of lights disposed on the absorbent material.
